(19) United States
(12) Patent Application Publication
(10) Pub. No.: US 2008/0016124 A1
(43) Pub. Date: Jan. 17, 2008

(54) Enabling N-way Data Replication with a Two Way Data Replicator

(75) Inventors: Douglas S. Rothert, Austin, TX (US); Radhakrishnan Sethuraman, Austin, TX (US); Manuel Silveyra, Round Rock, TX (US)

Correspondence Address: CANTOR COLBURN LLP - IBM AUSTIN, 55 GRIFFIN ROAD SOUTH, BLOOMFIELD, CT, 06002, US

(73) Assignee: INTERNATIONAL BUSINESS MACHINES CORPORATION, Armonk, NY (US)

(21) Appl. No.: 11/456,888

(22) Filed: Jul. 12, 2006

(51) Int. Cl. G06F 17/30

(52) U.S. Cl. 707/201

(57) ABSTRACT

A system and method for replicating data to multiple replica copies. The method includes connecting a replication device housing a replica data source to a primary data source via a network for communicating. Then, establishing a replication session between the primary data source and the replica data source. Then, transmitting the data from the primary data source to the replica data source. Then, replicating the transmitted data on the replica data source. Then, multicasting the replicated data from the replication device to a plurality of secondary devices in communication with the replication device via the network. Each secondary device storing a replica of the primary data source, wherein the replication device has a fixed IP address and when secondary devices are configured for data replication, the secondary device is configured with its own IP address and the IP address of the replication device as a remote IP address.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

### Field of Invention

This invention relates in general to the distribution of information for sharing among user groups, and more particularly, to a method and system for replicating data to multiple replica copies.

### DESCRIPTION OF BACKGROUND

Conventional data replication software supports only 2-way data replication. This type of data replication is not scalable when the need for increased processing power and availability arises. For example, open source software DRBD, which is predominantly used in the retail sector, falls into this type of data group.

Thus, there is a need to improve the scalability of such applications up to N-nodes without having to make significant changes to the existing software on the replication system.

### SUMMARY OF THE INVENTION

The shortcomings of the prior art are overcome and additional advantages are provided through the provision of a method for replicating data to multiple replica copies, comprising: connecting a replication device housing a replica data source to a primary data source via a network for communicating, the primary data source being configured to store data and to transmit the stored data during an established replication session; establishing the replication session between the primary data source and the replica data source; transmitting the data from the primary data source to the replica data source; replicating the transmitted data on the replica data source, the replica data source being configured to receive and replicate the transmitted data during the replication session; and multicasting the replicated data from the replication device to a plurality of secondary devices in communication with the replication device via the network, each receiving device being a replica of the primary data source, wherein the replication device has a fixed IP address and when secondary devices are configured for data replication, the secondary device is configured with its own IP address and the IP address of the replication device as a remote IP address.

The shortcomings of the prior art are overcome and additional advantages are provided through the provision of a system for replicating data to multiple replica copies, the system comprising: a replication device housing a replica data source configured to receive and replicate data during an established replication session; a primary data source communicatively coupled to the replication device via a network for communicating, the primary data source being configured to store data and to transmit the stored data via the network to the replica data source during an established replication session; and a plurality of secondary devices communicatively coupled to the router device via the network, each secondary device being a replica of the primary data source and each receiving data source configured to receive the data multicast from the replication device, wherein the replication device has a fixed IP address and when secondary devices are configured for data replication, the secondary device is configured with its own IP address and the IP address of the replication device as a remote IP address.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution for a method and system for replicating data to multiple replica copies.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawing in which:

FIG. 1 illustrates one example of a system for replicating data.

The detailed description explains an exemplary embodiment of the invention, together with advantages and features, by way of example with reference to the drawing.

### DETAILED DESCRIPTION OF THE INVENTION

Referring to the Figure, a system 10 for replicating data to multiple replica copies, is shown. The system 10 includes a replication device 12 that houses a replica data source 14. The replication device 12 is configured to receive and replicate data during an established replication session.

A primary data source 20 is communicatively coupled to the replication device 12 by way of a network 40 used for communicating. As shown, the primary data source 20 is a computer 22 including a monitor 24 that is communicatively coupled to a central processing unit 26. The central processing unit 26 is also communicatively coupled to a keyboard 28 and a computer mouse 30. The primary data source 20 is pre-determined by a user of the system 10 prior to initiating a replication session. The replica data source 14 is a replica of the primary data source 20 but unlike the primary data source 20, the replica data source 14 does not require the ancillary components that the primary data source 14 includes, for example, no monitor 24 is included, etc. The primary data source 20 is configured to store data, and to transmit the stored data via the network 40 to the replica data source 14 during an established replication session. Thus, the primary data source 20 need only send data to the replication device 12 assuming that the replication device 12 is the only other element on network 40.

A plurality of secondary devices 50, 60 and 70 are communicatively coupled to the replication device 12 via the network 40. Each secondary device 50, 60 and 70 may be similar to the primary data source 20. Secondary device 50 includes a monitor 52 that is communicatively coupled to a central processing unit 54. The central processing unit 54 is also communicatively coupled to a keyboard 56 and a computer mouse 58. Likewise, secondary device 60 also includes a monitor 62 that is communicatively coupled to a central processing unit 64. The central processing unit 64 is also communicatively coupled to a keyboard 66 and a computer mouse 68. Additionally, secondary device 70 includes a monitor 72 that is communicatively coupled to a central processing unit 74. The central processing unit 74 is also communicatively coupled to a keyboard 76 and a computer mouse 78. Each secondary device 50, 60 and 70 is configured to receive the data that is replicated and multicast from the replication device 12.

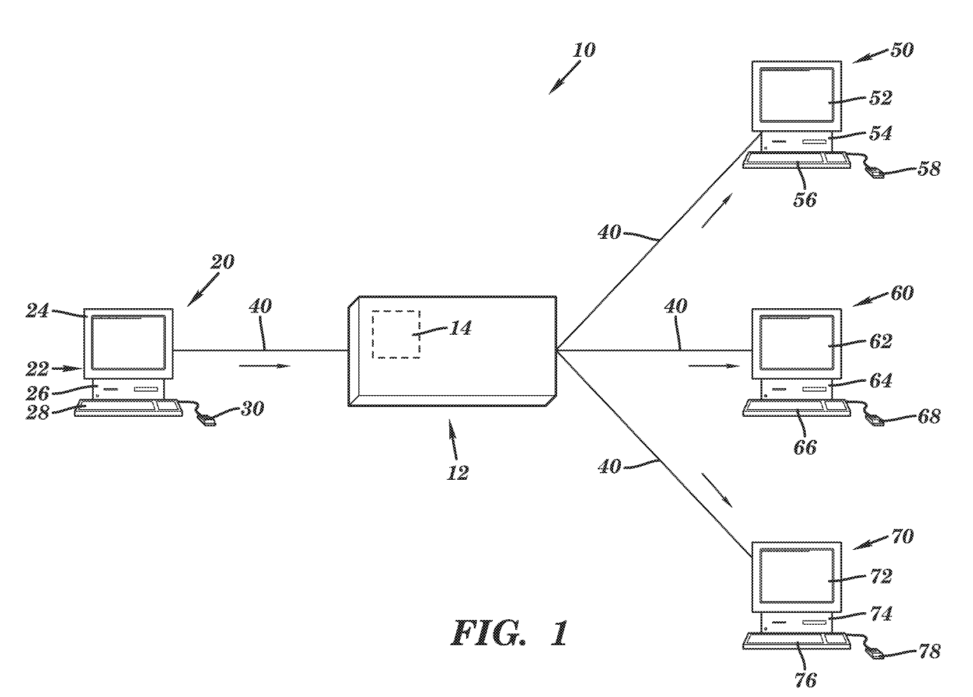

The primary data source 20 and the secondary devices 50, 60 and 70 are not limited to implementations as personal computers as depicted in FIG. 1. The primary data source 20 and the secondary devices 50, 60 and 70 may be implemented using a variety of devices for transmitting, receiving and storing data. Such devices include servers, PDAs, etc.

The replication device 12 has a fixed IP address. When devices are configured for data replication, the device is configured with its own IP address and the IP address of the replication device 12 as the remote IP address. Only one device serves as the primary data source 20.

In case of operational failure by the primary data source 20 during the replication session, the replication device 12 is configured to select a replacement primary data source 20 from secondary devices 50, 60 and 70. By configuring the replication device 12 to be able to select a replacement primary data source 20 in case of operational failure by the original primary data source 20, the replication session is ensured to be performed.

The system 10 includes software to initiate a method for replicating data to multiple replica copies. The method begins at a first step with a replication device 12, which houses a replica data source 14, being connected to a primary data source 20 via a network 40 for communicating. As previously explained, the primary data 20 source is configured to store data, and to transmit the stored data via the network 40 to the replica data source 14 during an established replication session.

At a second step, a replication session is initiated between the primary data source 20 and the replica data source 14.

At a third step, the primary data source 20 transmits the stored data to the replica data source 14.

At a fourth step, the replica data source 14 receives and replicates the transmitted data.

At a fifth step, the replication device 12 multicasts the replicated data to a plurality of secondary devices 50, 60 and 70, that are communicatively coupled via the network 40 to the replication device 12.

At a sixth step, the replication device 12 selects one of the secondary devices 50, 60 or 70 as the primary data source if the original primary data source 20 of the system 10 fails to operate properly. By configuring the replication device 12 to be able to select a replacement primary data source in case of operational failure by the original primary data source 20, the replication session is ensured to be performed.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for replicating data to multiple replica copies, comprising:
connecting a replication device housing a replica data source to a primary data source via a network for communicating, the primary data source being configured to store data and to transmit the stored data during an established replication session;
establishing the replication session between the primary data source and the replica data source;
transmitting the data from the primary data source to the replica data source;
replicating the transmitted data on the replica data source, the replica data source being configured to receive and replicate the transmitted data during the replication session; and
multicasting the replicated data from the replication device to a plurality of secondary devices in communication with the replication device via the network, each secondary device storing a replica of the primary data source;
wherein the replication device has a fixed IP address and when secondary devices are configured for data replication, the secondary device is configured with its own IP address and the IP address of the replication device as a remote IP address.

2. The method of claim 1, further comprising:
selecting a replacement primary data source from the secondary devices if the original primary data source fails to operate, the replication device being configured to select the replacement primary data source.

3. A system for replicating data to multiple replica copies, the system comprising:
a replication device housing a replica data source configured to receive and replicate data;
a primary data source communicatively coupled to the replication device via a network for communicating, the replica data source being a replica of the primary data source, the primary data source being configured to store data and to transmit the stored data via the network to the replica data source during an established replication session; and
a plurality of secondary devices communicatively coupled to the replication device via the network, each secondary device being a replica of the primary data source and each secondary device configured to receive the data multicast from the replication device;
wherein the replication device has a fixed IP address and when secondary devices are configured for data replication, the secondary device is configured with its own IP address and the IP address of the replication device as a remote IP address.

4. The system of claim 3, wherein the replication device is configured to select a replacement primary data source from the secondary devices if the original primary data source fails to operate.
